(19) United States
(12) Patent Application Publication
(10) Pub. No.: US 2013/0090882 A1
(43) Pub. Date: Apr. 11, 2013

(54) METHOD FOR IDENTIFYING FAULTY MEASUREMENT AXES OF A TRIAXIS SENSOR

(71) Applicants: Cedric Berbra, Tencin (FR); Suzanne Lesecq, Froges (FR)

(72) Inventors: Cedric Berbra, Tencin (FR); Suzanne Lesecq, Froges (FR)

(73) Assignee: Commissariat a l'energie atomique et aux energies alternatives, Paris (FR)

(21) Appl. No.: 13/649,433

(22) Filed: Oct. 11, 2012

(30) Foreign Application Priority Data
Oct. 11, 2011 (FR) 1159161

(51) Int. Cl. G06F 19/00; G01D 18/00

(52) U.S. Cl. 702/104

(57) ABSTRACT

A method for identifying faulty measurement axes of a triaxis sensor fixed to a mobile object includes using triaxis sensor Cⱼ fixed to the object, measuring vector bₘⱼ, using triaxis sensor Cᵢ fixed to the object, measuring vector bₘᵢ, the fields being represented by normalized vectors rᵢ and rⱼ such that scalar and vector products of rᵢ and rⱼ are known at any point, building vector bₑⱼ corresponding to an estimate of the measurement by Cⱼ at the measurement point without bₘⱼ, obtaining residues based on bₑⱼ and bₘⱼ and identifying faulty measurements of Cⱼ having as a function of residues, wherein building bₑⱼ comprises using scalar and vector products of rᵢ and rⱼ, and bₘᵢ so that a direction of bₑⱼ relative to bₘᵢ matches a direction of rⱼ relative to rᵢ.

### RELATED APPLICATIONS

Under 35 USC 119, this application claims the benefit of the priority date of French application FR 1,159,161, filed on Oct. 11, 2011, the contents of which are herein incorporated by reference.

### BACKGROUND

The invention pertains to a method and a device for identifying faulty measurement axes of a triaxis sensor fixed to a mobile object in a fixed referential system. An object of the invention is also an information-recording medium for implementing this method.

A triaxis sensor is a sensor capable of measuring the direction, and generally the amplitude, of a field of a physical quantity in a 3D space. To this end, it comprises at least three axes of measurement that are not parallel to one another.

The identification of the faulty measurement axis or axes of a triaxis sensor is for example used in methods for locating the mobile object. Indeed, the measurements coming from faulty measurement axes are then discarded or weighted to determine the position or orientation of the mobile object.

Known identification methods comprise:

the measurement, by a triaxis sensor Cⱼ fixed to the mobile object, of a vector bₘⱼ giving the direction of a first field of a physical quantity at a measurement point in a mobile referential system that is fixed without any degree of freedom to the mobile object.

the measurement by a triaxis sensor Cᵢ, fixed to the same mobile object, of a vector bₘᵢ giving the direction of a second field of a physical quantity at the same measurement point in the same mobile referential system, the first and second fields being represented, at any point of a working space within which the movements of the mobile object are limited, by vectors, respectively rⱼ and rᵢ, giving the direction of the field at this point, these first and second fields being such that the scalar and vector products, in the fixed referential system, of the normalized vectors rᵢ and rⱼ are known at any point of this working space,

the building of a vector bₑⱼ corresponding to the estimation of the measurement by the sensor Cⱼ at the measurement point without using the measurement bₘⱼ,

the computation of the difference between the vectors bₑⱼ and bₘⱼ to obtain a residual vector having, as coordinates along each axis of the mobile referential system, a residue corresponding to the difference between the coordinates of the vectors bₑⱼ and bₘⱼ on this axis of the mobile referential system, and

the identification of the measurement axis or axes of the sensor Cⱼ having a fault as a function of the residues computed on each of the axes of the mobile referential system.

The term “normalized vector” herein designates a vector for which each coordinate has been divided by the norm of this vector. The norm of a vector is given, for example, by the Euclidean norm.

For example, such a method is disclosed in the following document:

C. Berbra, S. Gentil and S. Lesecq, <<Identification of Multiple Faults in an Inertial Measurement Unit>>, 7th Workshop on Advanced Control and Diagnosis (ACD'2009), Zielona Gora, P1, November 2009.

In this document, the sensors Cᵢ and Cⱼ are, respectively, triaxis accelerometers and triaxis magnetometers.

To build the vector bₑⱼ, it is necessary to:

have available a specific model of the mobile object in the form of a system of equations which relates the different measurements of the sensors fixed on this object to one another, and

have redundant measurements, i.e. where the number of measurements made simultaneously by the sensors is strictly greater than the number of unknowns in the system of equations of the model of the mobile object.

In these conditions, from a limited number of measurements, it is possible to estimate the other measurements. Then, the estimated measurements are subtracted from the actually made measurements to identify the faulty measurement axis or axes. A measurement axis is said to be “faulty” if the error of measurement of the field along this axis goes beyond a predetermined threshold. The measurement along this axis can be disturbed by a disturber distinct from the mobile object. For example, this disturber can be a metal mass in proximity to one of the measurement axes. The measurement axis can also be considered to be faulty because of a failure of the sensor itself on this particular measurement axis.

The known methods work well but require therefore a model of the object and a redundancy of the measurements.

Prior art is also known from:

NGUYEN H V and A1: <<Diagnosis of an inertial measurement unit based on set membership estimation>>, Control and Automation, 2009, Med <<09>>, 17th Mediterranean Conference on, IEEE Piscataway, N.J., USA, 24 Jun. 2009, pages 211-216,

FR2 777 365 A1.

### SUMMARY

The invention is aimed at proposing a method for identifying the faulty measurement axes of a triaxis sensor that does not call for redundancy between the sensors or require the availability of a specific model linking the different measurements to one another.

An object of the invention therefore is a method of this kind in which the building of the vector bₑⱼ is obtained from:

the scalar and vector products of the vectors rᵢ and rⱼ, and

the measurement of the vector bₘᵢ,

in such a way that the direction of the vector bₑⱼ relatively to the vector bₘᵢ is identical to the direction of the vector rⱼ relatively to the vector rᵢ.

The measurements bₘᵢ and bₘⱼ correspond, respectively, to the vectors rᵢ and rⱼ, but do so in the mobile referential system. The angular relation between the vectors rᵢ and rⱼ is known in the fixed referential system. Hence, if the measurements bₘᵢ and bₘⱼ; are healthy, i.e. devoid of any detectable faults, then the angular relationship between vectors bₘᵢ and bₘⱼ is the same as the angular relationship between the vectors rᵢ and rⱼ. By using this property, it is possible to build the estimation bₑⱼ without its being necessary, for this purpose, to have available a specific model of the mobile object which links the different measurements of the sensors Cᵢ and Cⱼ to one another Thus, this method can be used with any object whatsoever without its being necessary to have prior knowledge of the geometry or properties of this object.

Furthermore, it is no longer necessary that there should exist any redundancy between the measurements of the sensors Cᵢ and Cⱼ. Finally, this method makes it possible to identify the measurement axis of the triaxis sensor that is faulty and not just the fact that this sensor is faulty.

The embodiments of this method may comprise one or more of the following characteristics:

The identification of the faulty measurement axis or axes comprises the conversion of each coordinate of the residual vector into a Boolean value encodable on only one information bit in applying Neyman-Pearson hypothesis testing to obtain a symptom vector, this Boolean vector indicating the presence of a fault in one state and the absence of any fault in the other state;

The estimation of the vector bₑⱼ is built out of the following relationships:

rᵢ .rⱼ=bₘᵢ .bₑⱼ, and

∥rᵢΛrⱼ∥=∥bₘᵢΛbₑⱼ∥,

∥bₑⱼ∥=∥rⱼ∥ when the first physical quantity field is such that the norm ∥rⱼ∥ is constant at any point of the working space or ∥bₑⱼ/bₘᵢ∥=∥rⱼ/rᵢ∥ when the first and second physical quantity fields are such that the ratio of the amplitudes of the vectors rᵢ and rⱼ at any point of the working space is constant.

where:

the symbol <<.>> is the scalar product function,

the symbol Λ is the vector product function, and

the symbol ∥x∥ is the Euclidian norm of the vector;

the axes of the mobile referential system coincide with the measurement axes of the sensor Cⱼ;

the method comprises:

the verification of the following relationship: ∥rᵢ∥=∥bₘᵢ∥ to within ±ε∥rᵢ∥, where ε is a constant smaller than or equal to 0.25 and ∥ . . . ∥ designates the norm of the vector, and

if this relationship is not verified, the systematic inhibiting of the building of the vectors bₑⱼ from the scalar and vector products of the vectors rᵢ and rⱼ and from the measurement of the vector bₘᵢ and, if not, the building of the vectors b_{ej ;}

the first and second fields are fields of two different physical quantities or the first and second fields are the same fields of the same physical quantity;

the first and second fields are chosen from the group formed by the earth's magnetic field and the gravitational field;

the measurements by the sensors Cⱼ and Cᵢ are measurements respectively of the first and second fields such that the scalar and vector products, in the fixed referential system, of the normalized vectors rᵢ and rⱼ are identical at every point of the working space.

The embodiments of this method furthermore have the following advantages:

converting the coordinates of the residual vector into Boolean values to identify the faulty measurement axis or axes increases the reliability of detection of the faulty measurement axis,

measuring the first and second fields so that the normalized vectors rᵢ and rⱼ are identical at every point of the working space removes the need to know the position or movements of the mobile object in the working space.

An object of the invention is also an information-recording medium comprising instructions to execute the above method when these instructions are executed by an electronic computer.

Finally, an object of the invention is also a device for identifying faulty measurement axes of a triaxis sensor Cⱼ fixed on a mobile object in a fixed referential system, this triaxis sensor Cⱼ measuring a vector bₘⱼ giving the direction of a first field of a physical quantity at a point of measurement in a mobile referential system fixed without any degree of freedom to the mobile object, this device comprising:

a triaxis sensor Cᵢ that is to be fixed to the same mobile object, this triaxis sensor Cᵢ being capable of measuring a vector bₘᵢ giving the direction of a second field of a physical quantity at the same point of measurement in the same mobile referential system, the first and second fields being represented, at every point of a working space within which the movements of the mobile object are limited, by vectors, rⱼ and rᵢ, respectively, giving the direction of the field at this point, these first and second fields being such that the scalar and vector products, in the fixed referential system, of the normalized vectors rᵢ and rⱼ are known at every point of this working space,

an electronic processing unit (12) capable of acquiring the measurements of the sensors Cᵢ and Cⱼ, this processing unit being programmed to:

build a vector bₑⱼ corresponding to the estimation of the measurement by the sensor Cⱼ at the point of measurement without using the measurement bₘⱼ,

compute the difference between the vectors bₑⱼ and bₘⱼ to obtain a residual vector having, for coordinates along each axis of the mobile referential system, a residue corresponding to the difference between the coordinates of the vectors bₑⱼ and bₘⱼ on this axis of the mobile referential system,

identify the measurement axis or axes of the sensor Cⱼ having a fault as a function of the residues computed on each of the axes of the mobile referential system, and

build the vector bₑⱼ from:

the scalar and vector products of the vectors rᵢ and rⱼ, and

the measurement of the vector bₘᵢ,

in such a way that the direction of the vector bₑⱼ relatively to the vector bₘᵢ is identical to the direction of the vector rⱼ relatively to the vector rᵢ.

### BRIEF DESCRIPTION OF THE DRAWINGS

The invention will be understood more clearly from the following description, given purely by way of a non-exhaustive example and made with reference to the appended drawings, of which:

FIG. 1 is a schematic illustration of a system for determining the orientation of a mobile object,

FIG. 2 is a flowchart of a method for identifying a faulty measurement axis and for determining the orientation of the mobile object of FIG. 1, and

FIGS. 3 to 8 are graphs representing different experimental results obtained by means of the method of FIG. 2.

In these figures, the same references are used to designate the same elements.

### DETAILED DESCRIPTION

Here below in this description, the characteristics and functions well known to those skilled in the art are not described in detail.

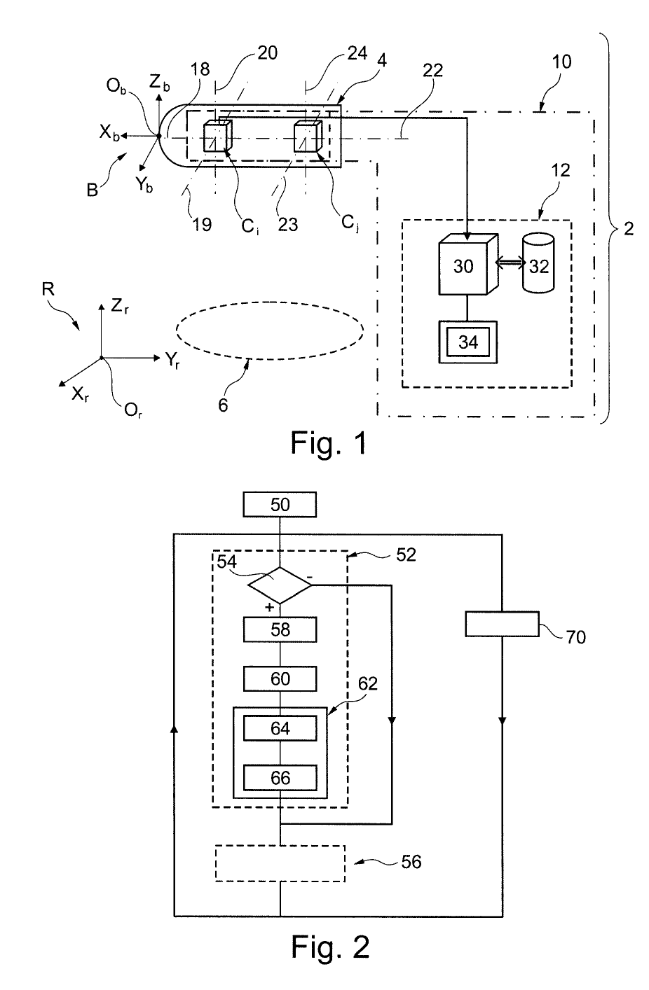

FIG. 1 represents a system 2 for determining the orientation of a mobile object 4 in a fixed referential system R. The orientation is also known by the term “attitude”.

The fixed referential system R is defined by three axes Xᵣ, Yᵣ and Zᵣ which are oriented and orthogonal to one another. Preferably, the referential system R is orthonormal. These axes intersect at a point Oᵣ forming the point of origin of the referential system R. The point Oᵣ is linked, without any degree of freedom, to the earth.

The mobile object 4 is capable of moving in the fixed referential system R. To this end, it is equipped with its own means of propulsion such as a motor or it is shifted by propulsion means external to the object 4. For example, the object 4 is a catheter to be introduced into the human body.

The object 4 moves solely inside a predetermined working space 6. The working space 6 is typically a 3D space. To simplify its representation in FIG. 1, this working space is represented solely by an oval in dashes. The working space 6 is linked without any degree of freedom to the referential system R.

A mobile referential system B is linked without any degree of freedom to the object 4. This referential system B, which is preferably orthonormal, is defined by three axes X_{b}, Y_{b} and Z_{b} oriented and orthogonal to one another. The point of origin of this referential system B is denoted as O_{b}.

The system 2 has an inertial measurement unit 10 fixed without any degree of freedom to the mobile object 4. This unit measures the orientation of the mobile object 4 in the fixed referential system R. More specifically, this unit 10 enables the measurement of the inclination of the mobile object 4 relatively to each of the axes Xᵣ, Yᵣ and Zᵣ of the referential system R.

To this end, the inertial measurement unit 10 is equipped with two sensors Cᵢ and Cⱼ connected to a processing unit 12.

In this embodiment, the sensors Cᵢ and Cⱼ are respectively a triaxis accelerometer and a triaxis magnetometer.

These sensors Cᵢ and Cⱼ are fixed in the referential system B.

The sensor Cᵢ measures the orthogonal projection of the acceleration of the object 4 on three measurement axes 18 to 20 which are not parallel to one another. Here, these axes 18 to 20 are orthogonal to one another. To simplify the description, the axes 18 to 20 are parallel, respectively, to the axes X_{b}, Y_{b} and Z_{b} of the referential system B. The sensor Cᵢ enables direct measurement of the direction and amplitude of the acceleration of the object 4 in the referential system B. The term “directly” herein designates the fact that it is not necessary to know the orientation of the referential system B relatively to the referential system A to obtain this measurement. The sensor Cᵢ measures especially the amplitude and direction of the earth's gravitational field. Here, the terms “amplitude” and “intensity” are used as synonyms.

The measurement of the sensor Cᵢ is denoted in the form of a vector bₘⱼ with three coordinates bₓₘᵢ, b_{ymi} and b_{zmi}, where the coordinates bₓₘᵢ, b_{ymi}, and b_{zmi} correspond to the intensities of the acceleration measured respectively along the axes 18 to 20.

The sensor Cⱼ measures the orthogonal projection of a static magnetic field, i.e. a magnetic field having zero frequency, present at the object 4 on three measurement axes 22 to 24 not parallel to one another. Here, these axes 22 to 24 are parallel respectively to the axes X_{b}, Y_{b} and Z_{b}. This sensor Cⱼ directly measures the direction and amplitude of the static magnetic field in the referential system B. It therefore measures the direction and amplitude of the earth's magnetic field.

This measurement of the sensor Cⱼ is denoted in the form of a vector bₘⱼ with three coordinates bₓₘⱼ, b_{ymj} and b_{zmj}, where the coordinates bₓₘⱼ, b_{ymj} and b_{zmj} correspond to the intensities of the static magnetic field measured, respectively, along the axes 22 to 24.

The measurements respectively of the earth's gravitational field and magnetic field in the reference field R are also denoted in the form of vectors rᵢ and rⱼ. As in the case of the vectors bₘᵢ and bₘⱼ, these two vectors rᵢ and rⱼ each have three coordinates, respectively (rₓᵢ, r_{yi}, r_{zi}) and (rₓⱼ, r_{yj}, r_{zj}). The coordinates rₓᵢ, r_{yi} and r_{zi} correspond to the measurements of the intensity of the earth's gravitational field, respectively, along the axes Xᵣ, Yᵣ and Zᵣ. The coordinates rₓⱼ, r_{yj} and r_{zj} correspond respectively to the measurements of the intensity of the earth's magnetic field respectively along the axes Xᵣ, Yᵣ and Zᵣ.

The working space 6 is limited enough so that the angular relationship between the vectors rᵢ and rⱼ can be considered to be identical at every point of this working space. This is expressed especially by the fact that, at any point of the working space 6, the following two relationships are verified:

rₙᵢ .r_{nj=α} (1)

∥rₙᵢΛrₙⱼ∥=β (2)

where:

rₙᵢ and rₙⱼ are the normalized vectors of the vectors rᵢ and rⱼ,

the symbol “.” is the scalar product function,

the symbol Λ is the vector product function,

the symbol ∥x∥ is the Euclidian norm of the vector x, and

α and β are constants independent of the point of the space 6 taken into account.

When the two previous relationships are verified, the fields are said to be reference fields and the vectors rᵢ and rⱼ are reference vectors.

Furthermore, here, the working space 6 is limited enough so that the norms of the vectors rᵢ and rⱼ can be considered to be identical at every point of the space 6. Thus, the following relationships are also verified:

rᵢ .rⱼ=A (3)

∥rᵢΛrⱼ∥=B (4),

where A and B are constants.

With these hypotheses and notations, when the object 4 is in a quasi-static state, the vectors bₘᵢ and bₘⱼ correspond respectively to the vectors rᵢ and rⱼ but are expressed in the referential system B instead of the referential system R.

The term “quasi-static” herein designates the fact that the contribution of the acceleration of the object 4 itself in the measurement bₘᵢ is negligible compared with that of the earth's gravitational field. For example, the object 4 is considered to be in the quasi-static state if ∥rᵢ∥=∥bₘᵢ∥ to within ±ε∥bₘᵢ∥, where ε is a constant. The value of ε depends on the application envisaged. For example, the value of ε is smaller than or equal to 0.25 and preferably smaller than or equal to 0.1 or 0.05 or 0.01.

Thus, when the object 4 is in the quasi-static state and if none of the measurement axes of the sensors Cᵢ and Cⱼ is faulty, then the angular relationship between the vectors bₘᵢ and bₘⱼ is the same as the angular relationship between the vectors rᵢ and rⱼ. This property is exploited by the processing unit 12 to identify one or more faulty measurement axes of the sensors Cᵢ and Cⱼ.

The processing unit 12 is capable of processing the measurements bₘⱼ and bₘᵢ in order to deduce therefrom the orientation of the object 4 in the fixed referential system R. It is also capable of identifying one or more faulty measurement axes of the sensors Cᵢ and Cⱼ from the measurements of the vectors b_{nd} and bₘᵢ. The unit 12 can be fixed or not fixed to the object 4. Here, it is described in the particular case where it is fixed without any degree of freedom to the object 4. However, to simplify FIG. 1, the unit 12 has been represented outside the object 4.

For example, this processing unit 12 is formed by a programmable electronic computer 30 capable of executing instructions recorded on an information-recording medium. To this end, the computer 30 is connected to a memory 32 containing the data and instructions needed to execute the method of FIG. 2.

In addition, here, the processing unit comprises also a man/machine interface 34 such as a screen connected to the computer 30 to inform a human being as to which is the faulty measurement axis or which are the faulty measurement axes of the sensors Cᵢ and Cⱼ.

The combination of one of the sensors Cᵢ, Cⱼ and the processing unit 12 forms a device for identifying faulty measurement axes of the other one of these sensors.

The working of the system 2 shall now be described in greater detail with reference to the method of FIG. 2.

The method starts with a calibration step 50. During this step 50, the object 4 is kept still in the fixed referential system R in an orientation that is known relatively to the referential system R. Then, the vectors rᵢ and rⱼ are measured by means of the sensors Cᵢ and Cⱼ and their coordinates are expressed in the referential system R. During this calibration step, it is assumed that none of the measurement axes of these sensors is faulty.

Then, a phase 52 is performed for identifying faulty measurement axes of the sensor Cⱼ.

This phase starts with a step 54 for measuring the vectors bₘᵢ and bₘⱼ and then for ascertaining that the sensor Cᵢ is usable. In this step, it is sought solely to verify that the sensor Cᵢ can be used to identify the failure of one of the measurement axes of the sensor Cⱼ. This sensor Cᵢ is considered to be usable if it is neither faulty nor out of the quasi-static state. Thus, here, in this step 52, it is not sought to identify the faulty measurement axis or axes of the sensor Cᵢ.

For example, in this embodiment, the sensor Cᵢ is considered to be usable if the following relationship (5) is verified to within ±ε∥rᵢ∥, where ε is a constant predetermined as a function of the application envisaged. For example, the value of ε is smaller than or equal to 0.25 and preferably smaller than or equal to 0.1 or 0.05 or 0.01:

∥rᵢ∥=∥bₘᵢ∥ (5),

where ∥ . . . ∥ designates the norm of the vector.

If the sensor Cᵢ is not considered to be usable, then the method proceeds directly to a phase 56 for identifying faulty axes of measurement of the sensor Cᵢ.

If not, in a step 58, the computer 30 builds a vector bₑⱼ which corresponds to the estimation of the measurement by the sensor Cⱼ which would be obtained in the absence of faults on all the measurement axes. This estimation is built using neither the measurement bₘⱼ nor a model of the object 4 nor the position or orientation of the object 4 in the referential system R. To this end, the invention uses the property according to which the angular relationship between the vectors bₑⱼ and bₘᵢ is identical to the angular relationship between the vectors rⱼ and rᵢ when there is no fault on the measurement axes of the sensor Cⱼ. Furthermore, here, the norms of the vectors bₑⱼ and bₘᵢ must be identical to the norms respectively, of the vectors rⱼ and rᵢ. Keeping the angular relationship and the norm makes it possible to write the following system of equations:

rⱼ .rᵢ=bₑⱼ .bₘᵢ (6)

∥rⱼΛrᵢ∥=∥bₑⱼΛbₘᵢ∥ (7)

∥rⱼ∥=∥bₑⱼ∥ (8)

The resolution of this system of equations gives the coordinates of the vector bₑⱼ. For example, to find the coordinates of the vector bₑⱼ, a search is made for the coordinates of the vector bₑⱼ which minimizes the following relationships by means of the least-squares method:

rⱼ .rᵢ−bₑⱼ .bₘᵢ (9)

∥rⱼΛrᵢ∥−∥bₑⱼΛbₘᵢ∥ (10)

∥rⱼ∥−∥bₑⱼ∥ (11)

Once the vector bₑⱼ has been built, in a step 60, the computer 30 computes a residual vector Vᵣⱼ. This vector Vᵣⱼ is defined by the following relationship:

Vᵣⱼ=bₑᵢ−bₘⱼ (12).

Each coordinate of the vector Vᵣⱼ is therefore a residue that is a function of the difference between the coordinates of the vectors bₑⱼ and bₘⱼ on the same axis of the referential system B.

If there is no fault on the measurement axes of the sensor Cⱼ, then the coordinates of the vector Vᵣⱼ must be equal to zero plus or minus a margin of error related especially to the noise on the measurements of the vectors bₘⱼ and bₘᵢ.

At a step 62, the computer 30 identifies the faulty measurement axis or axes of the sensor Cⱼ from the residual vector Vᵣⱼ.

For example, in an operation 64, the computer 30 converts the vector Vᵣⱼ into a symptom vector Vₛⱼ. To this end, each coordinate of the vector Vᵣⱼ is converted into a Boolean value by applying a hypothesis test. Here, the hypothesis test is the Neyman-Pearson test. This Neyman-Pearson test is for example described in the following documents:

Michèle Basseville, Igor V. Nikiforov, “Detection of Abrupt Changes—Theory and Application”, Prentice-Hall, Inc., ISBN 0-13-126780-9—April 1993—Englewood Cliffs, N.J., (see especially chapter 4.2 and the theorem in chapter 4.2.1)

S. Lesecq, “Chapitre 2. Traitement du signal pour le diagnostic” dans “Supervision des procédés complexes”, (“Chapter 2. Signal processing for diagnostics” in “Supervision of complex methods”), Lavoisier, 2007.

For example, the different parameters of the test are chosen as follows:

Hypothesis H₀: the mean value when there is no fault is fixed at 0,

Hypothesis H₁: the mean value when there is a fault is greater than or equal to 0.1, and

the probability of a false alarm is taken to be equal to 5%.

Then, in an operation 66, the computer 30 compares the symptom vector Vₛⱼ with a table of signatures of faults. The fault signature table is for example the following table:

| Fault/Symptom | fₘₓ | f_{my} | f_{mz} |
|---|---|---|---|
| Sₓⱼ | 1 | 0 | 0 |
| S_{yj} | 0 | 1 | 0 |
| S_{zj} | 0 | 0 | 1 |

The columns fₘₓ, f_{my} and f_{mz} correspond to faults respectively on the measurement axes 22 to 24. The rows Sₓⱼ, S_{yj} and S_{zj} correspond to the coordinates of the vector Vₛⱼ on the axes X_{b}, Y_{b} and Z_{b}.

In this table, a symbol “1” in one of the columns fₘₓ, f_{my} and f_{mz} means that there is a fault on the corresponding measurement axis. On the contrary, a symbol “0” means that there is no fault on the corresponding measurement axis.

Thus, the symptom (1, 0, 0) is interpreted from this table of signatures as signifying that only the measurement axis 22 is faulty.

In another example, the symptom (1, 1, 0) means that only the measurement axes 22 and 23 of the sensor Cⱼ are faulty.

After having proceeded to the phase 52, at the end of the step 62, the computer executes the phase 56 for identifying faulty measurement axes of the sensor Cᵢ. This phase 56 is for example carried out similarly to the phase 52. For example, the phase 56 is carried out like the phase 52 described here above but in replacing the index i by the index j and vice versa. At the phase 56, the table of signatures indicates the faults on the axes 22 to 24 from the symptom vector Vₛᵢ.

It will also be noted that, if the two sensors Cᵢ and Cⱼ are considered to be “non-usable” at the step 54, then it is not possible to identify precisely the faulty measurement axis or axes. In this case, the computer 30 indicates only that the sensors Cᵢ and Cⱼ are faulty without specifying the faulty measurement axes.

The phases 52 and 56 are reiterated at regular intervals. At the same time, at a step 70, the pieces of information on the faulty measurement axes are taken into account by the computer 30 when determining the orientation of the object 4. For example, in response to the identification of one or more faulty measurement axes, the orientation of the object 4 is determined without using the measurements on the faulty measurement axis or axes. It is also possible to use the measurements made on the faulty axes but in giving these measurements a weighting coefficient which gives them less weight in determining the orientation of the object 4.

In response to the identification of one or more faulty measurement axes, the computer 30 also informs the user of the system 2 about the existence of these faulty axes through the man/machine interface 34.

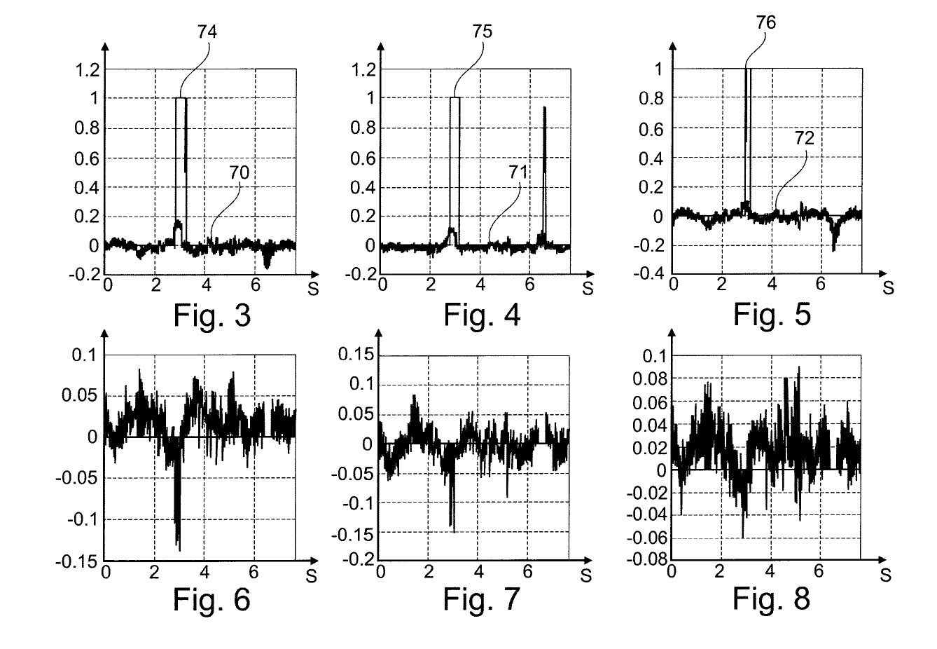

In FIGS. 3 to 5, curves, 70 to 72 respectively, represent the progress in time of each of the coordinates of the residual vector Vᵣᵢ. On these same graphs, these curves 74 to 76 represent the progress of the coordinates of the symptom vector Vₛᵢ. The x-axis of these graphs is graduated in seconds.

These curves were obtained in the particular case where a fault appeared simultaneously on the three measurement axes of the sensor Cᵢ between the second and the fourth second. Later, a fault appeared on the measurement axis 23 after the sixth second (see FIG. 4).

FIGS. 6 to 8 represent the progress in time of the coordinates of the residual vector Vᵣⱼ respectively along the axes 18 to 20 during the same period as that of FIGS. 3 to 4.

As shown by these graphs obtained by digital simulation, the method described in response to FIG. 2 enables the detection and identification simultaneously of several faulty measurement axes as well as a single faulty measurement axis.

Many other embodiments are possible. For example, only the angular relationship between the vectors bₘᵢ, bₘⱼ, rᵢ and rⱼ is used and not the relationship between the norms of these vectors. To this end, in the relationships (6) to (8), these normalized vectors bₙₘⱼ, bₙₘᵢ, rₙⱼ and rₙᵢ are used instead of the non-normalized vectors respectively bₘⱼ, bₘᵢ, rⱼ and rᵢ. The relationship (8) is then written as: ∥bₑⱼ∥=1. In this embodiment, it is not necessary for the sensors Cᵢ and Cⱼ to measure the amplitude of the field of the physical quantity in addition to its direction. In addition, the norm of the vectors rᵢ and/or rⱼ does not need to be constant at every point of the working space.

The relationship (8) can also be replaced by the following: ∥bₑⱼ∥/∥bₘᵢ∥=∥rⱼ∥/∥rᵢ∥ when the ratio of the amplitudes of the vectors rᵢ and rⱼ at any point of the working space is constant.

In another embodiment, it is not necessary for the scalar and vector products of the vectors rᵢ and rⱼ to be constant at every point of the working space. In fact, it is enough for the values of these products to be known at every point of the working space. In this case, for example, a pre-recorded table associates, with the x, y, z coordinates of each point of the working space, the values α(x,y,z) and β(x,y,z) respectively of the scalar and vector products of the vectors rᵢ and rⱼ. Then, at the identification of the faulty axis of the sensor Cⱼ, the following relationships are used instead of the relationships (8), (9) and (10) to estimate the vector bₑⱼ:

α(x,y,z)−bₑⱼ .bₘᵢ

β(x,y, z)−∥bₑⱼΛbₘᵢ∥

∥rⱼ∥−∥bₑⱼ∥

The values α(x,y,z) and β(x,y,z) are obtained through knowledge of the position of the mobile object and the pre-recorded table. There are different ways of knowing the position of the mobile object. For example, this position can be measured by means of other sensors. It can also be planned to position the mobile object at a known point of the working space and then implement the method for identifying faulty axes only when the mobile object is situated at a known point of space. In this variant, preferably, the normalized vectors are used.

There are fields of reference other than the earth's magnetic field and the earth's gravitational field. For example, a star sensor enables the measurement of the direction in which a star is located. The measured direction is fixed and is the same at every point of a fixed referential system. For example, the fixed referential system is in this case a geocentric referential system. A star sensor of this kind is described in greater detail in the following article:

W. H. Steyn, M. J. Jacobs and P. J. Oosthuizen, “A High Performance Star Sensor System for Full Attitude Determination on a Microsatellite”, Department of Electronic Engineering, University of Stellenbosch, Stellenbosch 7600, South Africa.

The reference field can also be generated artificially, for example by means of a permanent magnet or electrical coil placed in the working space.

All the reference fields can be identical and therefore the vectors rᵢ and rⱼ can be identical. For example, in a simplified embodiment, one and only one reference field is used. In this case, the sensors Cᵢ and Cⱼ measure the same field. The measurement axes of these two identical sensors are not necessarily parallel to each other. Thus, the sensors Cᵢ and Cⱼ can be both accelerometers.

It is not necessary for both sensors Cᵢ and Cⱼ to be fixed in the mobile referential system B. Indeed, one of the two sensors can be mobile relatively to the other in the mobile referential system B. In this case, at each instant, the orientation of the mobile sensor in the mobile referential system must be known so that its measurement can be converted into a vector expressed in the mobile referential system.

Other methods for identifying faulty measurement axes from the residual vector are possible. For example, as a variant, when one of the coordinates of the residual vector crosses a predetermined threshold, the corresponding measurement axis corresponding to this coordinate is considered to be faulty.

As a variant, the axes of the mobile referential system do not coincide with the measurement axes. This embodiment can easily be related to the case of the embodiment described here by a simple change of referential system.

Other methods of computing the residual vector are possible.

The comparison of the residual vector with the table of signatures can be done differently. For example, for each measurement axis, the table of signatures specifies a threshold Sᵢ for each coordinate of the residual vector on this axis. If this threshold is crossed, then the measurement axis is considered to be faulty.

The triaxis sensors can have more than three measurement axes. In this case, the vectors do not have three coordinates but as many coordinates as there are measurement axes.

The above embodiment has been described in the particular case where the mobile object moves in the fixed referential system. However, the method described can be applied whenever one of the two reference frames shifts relatively to the other.

Similarly, it is not necessary for the measurement axes of the sensors Cᵢ and Cⱼ to be parallel to each other. It is also possible to return to this situation by a simple change of reference frames.

What has been described in the particular case of two triaxis sensors can also be applied to the case of N triaxis sensors, where N is an integer greater than or equal to two. In this case, each triaxis sensor has to be capable of measuring its own field of reference of a physical quantity and it has available at least N reference vectors, i.e. one reference vector for each sensor. In this case, preferably, the vector bₑⱼ is built from the same angular relationships as described here above but expressed for each of the sensors Cᵢ, of a group of K sensors, where K is an integer greater than or equal to two, containing only sensors considered to be “usable”.

The method of identification of a faulty measurement axis can be applied in a large number of technical fields such as the reconstruction of human movement or the orientation of satellites.

Having described the invention, and a preferred embodiment thereof, what is claimed as new and secured by letters patent is:

1. A method for identifying faulty measurement axes of a triaxis sensor fixed to a mobile object in a fixed referential system, said method comprising using a first triaxis sensor Cⱼ fixed to said mobile object, measuring a first vector bₘⱼ that gives a direction of a first field of a physical quantity at a measurement point in a mobile referential system that is fixed without any degree of freedom to said mobile object, using a second triaxis sensor Cᵢ fixed to said mobile object, measuring a second vector bₘᵢ that gives a direction of a second field of a physical quantity at said measurement point in said mobile referential system, said first and second fields being represented, at any point of a working space within which movements of said mobile object are limited, by first and second normalized vectors rᵢ and rⱼ that give a direction of said fields at said measurement point, said first and second fields being such that scalar and vector products, in said fixed referential system, of said first and second normalized vectors rᵢ and rⱼ are known at any point of said working space, building a third vector bₑⱼ corresponding to an estimate of said measurement by said first triaxis sensor Cⱼ at said measurement point without using said first vector bₘⱼ, computing a difference between said third and first vectors bₑⱼ and bₘⱼ to obtain a residual vector having, as coordinates along each axis of said mobile referential system, a residue corresponding to a difference between coordinates of said third and first vectors bₑⱼ and bₘⱼ on said axis of said mobile referential system, and identifying one or more measurements of said first triaxis sensor Cⱼ having a fault as a function of residues computed on each of said axes of said mobile referential system, wherein building said third vector bₑⱼ comprises using scalar and vector products of said first and second normalized vectors rᵢ and rⱼ, and said measurement of said second vector bₘᵢ, in such a way that a direction of said third vector bₑⱼ relative to said second vector bₘᵢ is identical to a direction of said second normalized vector rⱼ relative to said first normalized vector rᵢ.

2. The method of claim 1, wherein identifying one or more measurements of said first triaxis sensor Cⱼ having a fault comprises converting each coordinate of said residual vector into a Boolean value encodable on only one information bit in applying Neyman-Pearson hypothesis testing to obtain a symptom vector, said Boolean value indicating presence of a fault in a first state and the absence of any fault in a second state.

3. The method of claim 1, wherein building a third vector bₑⱼ corresponding to an estimate of said measurement by said first triaxis sensor Cⱼ at said measurement point without using said first vector bₘⱼ comprises building said third vector based on the following relationships: rᵢ . rⱼ=bₘᵢ . bₑⱼ, ∥rᵢΛrⱼ∥=∥bₘᵢΛbₑⱼ∥, and ∥bₑⱼ∥=∥rⱼ∥ when said first physical quantity field is such that a norm ∥rⱼ∥ is constant at any point of said working space or ∥bₑⱼ/bₘᵢ∥=μrⱼ/rᵢ∥ when said first and second physical quantity fields are such that a ratio of amplitudes of said first and second normalized vectors rᵢ and rⱼ at any point of said working space is constant, wherein “.” represents a scalar product, “Λ” represents a vector product, and “∥x∥” represents a Euclidian norm of a vector x.

4. The method of claim 1, wherein said axes of the mobile referential system coincide with the measurement axes of said first triaxis sensor Cⱼ.

5. The method of claim 1, wherein said method further comprises attempting to verify that ∥rᵢ∥=∥bₘᵢ∥ to within ±ε∥rᵢ∥, wherein c is a constant less than or equal to 0.25 and “∥x∥” designates a norm of a vector x, if said attempt fails, systematically inhibiting building said third vector bₑⱼ from scalar and vector products of said first and second normalized vectors rᵢ and rⱼ and from measurement of said second vector bₘᵢ, and if said attempt succeeds, building said third vector bₑⱼ.

6. The method of claim 1, wherein said first and second fields are fields of two different physical quantities.

7. The method of claim 1, wherein said first and second fields are fields of a common physical quantity

8. The method of claim 1, wherein at least one of said first and second fields is earth's magnetic field.

9. The method of claim 1, wherein at least one of said first and second fields is a gravitational field.

10. The method of claim 1, wherein said measurements by said first and second triaxis sensors Cⱼ and Cᵢ comprise measurements respectively of said first and second fields such that scalar and vector products of said first and second normalized vectors rᵢ and rⱼ in said fixed referential system are identical at every point of said working space.

11. A manufacture comprising a tangible and non-transitory information-recording medium having encoded thereon software comprising instructions that, when executed by a data processing system, cause said data processing system to execute the method of claim 1.

12. An apparatus for identifying faulty measurement axes of a triaxis sensor Cⱼ fixed on a mobile object in a fixed referential system, said triaxis sensor Cⱼ being configured to measure a first vector bₘⱼ giving a direction of a first field of a physical quantity at a point of measurement in a mobile referential system fixed without any degree of freedom to said mobile object, said apparatus comprising a first triaxis sensor Cᵢ to be fixed to said mobile object, said first triaxis sensor Cᵢ being configured to measure a second vector bₘᵢ giving a direction of a second field of a physical quantity at said point of measurement in said mobile referential system, said first and second fields being represented, at any point of a working space within which movements of the mobile object are limited, by first and second normalized vectors, rⱼ and rᵢ, respectively, that give a direction of said first and second fields at said point, said first and second fields being such that scalar and vector products, in said fixed referential system, of said first and second normalized vectors rᵢ and rⱼ are known at any point of said working space, an electronic processing unit programmed to acquire measurements of said first and second sensors Cᵢ and Cⱼ, said electronic processing unit being programmed to build a third vector bₑⱼ corresponding to an estimate of a measurement by said second triaxis sensor Cⱼ at said point of measurement without using said second vector bₘⱼ, to compute a difference between said third and second vectors bₑⱼ and bₘⱼ to obtain a residual vector having, for coordinates along each axis of said mobile referential system, a residue corresponding to a difference between of coordinates of said vectors bₑⱼ and bₘⱼ on said axis of said mobile referential system, and to identify one or more measurement axes of said second triaxial sensor Cⱼ having a fault as a function of said residues computed on each of said axes of said mobile referential system, wherein said electronic processing unit is further programmed to build said third vector bₑⱼ from scalar and vector products of said first and second normalized vectors rᵢ and rⱼ, and from a measurement of said second vector bₘᵢ, in such a way that a direction of said third vector bₑⱼ relative to said second vector bₘᵢ is identical to a direction of said first normalized vector rⱼ relative to said second normalized vector rᵢ.
